(19) United States
(12) Patent Application Publication
(10) Pub. No.: US 2012/0316928 A1
(43) Pub. Date: Dec. 13, 2012

(54) CUSTOMER INTERACTION MANAGEMENT BLUEPRINT

(75) Inventors: GOVINDAN SHANKARAN NAIR, Thiruvanmiyur (IN); PARAMESWARAN EDAVANNA KOVILAKAM, Thiruvanmiyur (IN); MANU YEGNARAMAN, Thiruvanmiyur (IN); VAISHALI JAMES, Thiruvanmiyur (IN); VISHAKHA MAYANIKAR, Thiruvanmiyur (IN); GAURI BHAT, Thiruvanmiyur (IN); KESHAV KUMAR KRISHNASWAMY, Thiruvanmiyur (IN)

(73) Assignee: SERVION GLOBAL SOLUTIONS, LTD., Thiruvanmiyur (IN)

(21) Appl. No.: 13/155,834

(22) Filed: Jun. 8, 2011

(51) Int. Cl. G06Q 10/00

(52) U.S. Cl. 705/7.38

(57) ABSTRACT

The various embodiments of the present invention provide a Customer Interaction Management (CIM) blueprint methodology to assess the maturity of contact management in an organization and determine a series of measures in form of business and technology design blueprints to take the contact management to a desired position as per brand and business needs. The method of providing a CIM blueprint process includes assessing the current position of the customer interaction management, analyzing the gaps between the current and ideal states of the customer interaction management, advising a suitable blueprint to cover the gaps and assisting in the implementation of the blueprint to the customer interaction management. The customer interaction management blueprint cascades customer interaction management decisions using a plurality of decision making layers comprising brand layer business layer, financial-functional layer, operational layer and technology layer.

### CROSS-REFERENCE TO RELATED APPLICATIONS

The present application claims priority to provisional application serial number 1606/CHE/2010 filed on Jun. 10, 2010, and that application is incorporated in its entirety at least by reference.

### BACKGROUND

1. Technical field

The embodiments herein generally relate to Contact Management in organizations and more particularly to a Customer Interaction Management (CIM) Blueprinting and indexing.

2. Description of the Related Art

Every business needs to efficiently manage inbound and outbound interactions with the customers. These interactions occur through many channels including the web, call centers, branch offices, email etc. With the inbound interactions, the customers can visit a web site, make a call to the customer centre or go to a branch office to offer their attention to the organization as the customers may need information about a product or an assistance to solve a problem at that moment. These interactions usually present an opportunity to the organization to communicate with the customers who are engaged by own choice and ready to share information regarding his/her requirement. The outbound interactions are typically used to target particular customer segments based on the analysis of the customer data. The success of these interactions whether through email, direct mail or other channels depends to a great extent on the understanding of the organization about the requirements of the customer.

Each organization creates their own customer service strategies to grow up their business. The positioning of the contact centre has an important function in the organization since the contact centre has to be aligned to the strategic needs of the organization. Hence the organizations creating their customer service strategies need to adapt various optimal measures on how the customer interactions should be handled.

With the continuing changes in the requirements of the customers, the processes and technologies in use are frequently not able to keep up with the growing customer needs. As different interactions need to be handled differently, the choice of channels, sizing and processes for these interactions need to be assessed before setting up the interactions. The risk of taking a decision without a structured approach leads to either over investment or poor customer service. Thus an effective Customer Interaction Management (CIM) is a key differentiator for a business to treat their customers and manage the customer relationships in the highly competitive and dynamic environments.

Existing contact management methodologies are related to Customer Relationship Management (CRM). From an industry classification perspective, the main approach of the current methodologies are related to managing customer interactions on a day-to-day basis in the sense of collecting, storing and processing of information to take operation decisions. The current CIM methodologies are short term in nature, one-dimensional at a time and largely concentrate on efficiency paradigms like productivity. The current CIM methodologies are unable to align the contact management strategies to the brand and enterprise strategies and also lack in integrating the technology dimensions.

Hence there exists a need to provide a customer interaction management blueprint for enhancing the customer relationship management of an organization.

The above mentioned shortcomings, disadvantages and problems are addressed herein and which will be understood by reading and studying the following specification.

### SUMMARY OF THE EMBODIMENTS

The primary object of the embodiments herein is to develop a Customer Interaction Management (CIM) blueprint to improve the contact management of an organization by strategically aligning the contact management with the positioning of the organization.

Another object of the embodiments herein is to develop a Customer Interaction Management (CIM) blueprint to strategically align the business strategy of the organization with the contact management strategy and operations.

Another object of the embodiments herein is to develop a CIM blueprint to understand the internal gaps of the contact management.

Another object of the embodiments herein is to develop a CIM blueprint to diagnose the contact management maturity lifecycle in an organization.

Another object of the embodiments herein is to develop a CIM blueprint to absorb new customer interaction methods into the contact management framework.

Another object of the embodiments herein is to develop a CIM blueprint to measure the internal gaps between the consumer expectation and organization experience mismatch.

Another object of the embodiments herein is to develop a CIM blueprint to categorize, list and prioritize the internal gaps to clear problem areas with substantiation.

The various embodiments herein provide a Customer Interaction Management (CIM) blue print with business and technology designs to align the business strategy of the organization with its contact management strategy and operations. The CIM Blueprint is a detailed design of a customer interaction management technology based on the business requirements of the organization. The method of providing a CIM blue print process comprising steps of assessing a current position of a customer interaction management in an organization, analysing gap between the current position and an expected position of the customer interaction management, advising a blueprint to cover the gap between the current position and the expected position of the customer interaction management and assisting in the implementation of the blueprint to the customer interaction management. The customer interaction management blueprint cascades customer interaction management decisions using a plurality of decision making layers comprising brand layer, business layer, financial-functional layer, operational layer and technology layer.

According to an embodiment of the present disclosure, the customer interaction landscape of an organization is assessed based on the interplay between a plurality of parameters including customer experience, customer accessibility and capacity to deliver.

According to an embodiment of the present disclosure, the method of assessment of the current position of the customer interaction management comprises at least one of a series of assessment techniques including customer interaction management positioning, customer interaction management indexing, activity based costing, business process mapping, customer experience management, customer behaviour analysis, capacity modelling, process and quality management and technology assessment.

According to an embodiment of the present disclosure, the customer interaction management positioning for the assessment of the current position of the customer interaction management comprising understanding parameters used for creating strategies of the organization by discussing with key stakeholders of the organization, understanding a manner of creating the parameters which are implemented in the processes of customer interaction management from the key stakeholders of the organization, linking the parameters to the manner of creating the parameters to arrive at a key positioning statement for the customer interaction management and converting the key positioning statement into a set of objectives for the customer interaction management to identify a role of the customer interaction management.

According to an embodiment of the present disclosure, customer interaction management indexing for the assessment of the current position of the customer interaction management comprising understanding the current position of the customer interaction management against a customer interaction management indexing framework.

According to an embodiment of the present disclosure, the customer interaction management indexing framework for performing the assessment of the current position of the customer interaction management comprises a brand adapted to drive a strategic positioning of the contact management, strategies to drive practices which apply on the processes and the extent of usage of a process which impacts the interaction at the point of contact. The CIM indexing framework determines cost variable, revenue variable and experience variable to index the contact management practices of the organization.

According to an embodiment of the present disclosure, the activity based costing for the assessment of the current position of the customer interaction management comprising analyzing operational inefficiencies in the current position of the customer interaction management and providing instructions adapted for implementing technologies and processes required for improving efficiency of work flow.

According to an embodiment of the present disclosure, the business process mapping for the assessment of the current position of the customer interaction management, comprising finding a point of initiation and a point of conclusion of the processes analyzed through a customer interaction management framework and creating business process maps for the processes in the customer interaction management.

According to an embodiment of the present disclosure, the customer experience management for the assessment of the current position of the customer interaction management comprising assessing objectives implemented to improve the customer experience and objectives linked to the strategic organization objectives at the organization level, assessing customer experience objectives understood by stakeholders, translating the strategic organization objectives into the customer experience objectives, implementing the customer experience objectives in processes and policies of the customer interaction management and employing reviewing metrics to measure effectiveness of the improved customer experience processes.

According to an embodiment of the present disclosure, the capacity modeling for the assessment of the current position of the customer interaction management comprising matching workload forecasts with the customer interaction management capacity forecasted for a period of time, examining a balance period between workload and capacity forecasted, wherein the workload and capacity are modelled with a set of inflationary and deflationary parameters and assessing capacity of the customer interaction management based on the balance period.

According to an embodiment of the present disclosure, the customer behavior analysis for the assessment of the current position of the customer interaction management comprising identifying self service potential of the organization using work elements, wherein the work element includes at least one of a self-service foot print audit, self-service traffic modelling, mystery shopping, self-service analytics, cross channel views and so on.

According to an embodiment of the present disclosure, the process and quality management for the assessment of the current position of the customer interaction management comprising assessing at least one current operation setup of the customer interaction management, comparing the current operation with standard practices and identifying the critical points in the customer interaction management processes to provide improved customer service.

According to an embodiment of the present disclosure, the technology assessment method for assessing current position of the customer interaction management comprising assessing a performance of a current technology and a current architecture used in the customer interaction management with industry benchmarks and trends.

According to an embodiment of the present disclosure, analyzing the gap between the current position and the expected position of the customer interaction management, further comprising identifying problems in the positioning of the customer interaction management from the series of assessment techniques, categorizing the identified problems, using a CIM indexing methodology to arrive the problems having highest impact on positioning and providing substantiation for the identified problems.

According to an embodiment of the present disclosure, advising of a blueprint to cover the gap between the current position and the expected position of the customer interaction management further comprising providing solutions for identified problems, listing the solutions for the problems in positioning of the customer interaction management, building a business design having a set of improvement initiatives for the solutions and building a technology design for the solutions identified in the business design, wherein the technology design refers to concept and technologies of the customer interaction management.

According to an embodiment of the present disclosure, method of assisting in the implementation of the blueprint to the customer interaction management further comprising implementing bottleneck operations in business and technology designs of the customer interaction management, processing competency augmentation, audit and calibrations in business and technology designs of the customer interaction management and modifying the blueprint according to requirements added in the customer interaction management.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a Customer Interaction Management (CIM) blueprint according to an embodiment of the present disclosure.

FIG. 2 illustrates a flowchart representing a method of diagnosing maturity of a contact management in an organization using the Customer Interaction Management (CIM) blueprint according to an embodiment of the present disclosure.

FIG. 3 illustrates a flowchart representing a method of identifying problem and solution statements for a contact management using a Customer Interaction Management (CIM) indexing according to an embodiment of the present disclosure.

FIG. 4 illustrates a flowchart representing a method of understanding alignment of an organization brand to the positioning of the contact management according to an embodiment of the present disclosure.

FIG. 5 illustrates a functional block diagram representing an example customer interaction framework to study the business process involved in customer interaction management according to an embodiment of the present disclosure.

FIG. 6 illustrates a flow chart explaining the method of Customer Interaction Management (CIM) indexing according to an embodiment of the present disclosure.

FIG. 7 illustrates a schematic representation of current and ideal state of contact positioning in a Customer Interaction Management (CIM) blueprint according to an embodiment of the present disclosure.

FIG. 8 illustrates a schematic representation of a CIM indexing framework according to an embodiment of the present disclosure.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a Customer Interaction Management (CIM) blueprint methodology to assess the maturity of contact management in an organization and determine a series of measures in form of business and technology design blueprints to take the contact management to a desired position as per brand and business needs. According to one embodiment herein, a CIM Blueprint is a detailed design of a customer interaction management blueprint based on the business requirements. The CIM blueprint is an assessment technique of the customer interaction landscape of the organization. The customer interaction landscape is a result of interactions between one or more parameters like customer experience, customer accessibility, and capacity to deliver products and/or services and so on.

The CIM blueprint includes one or more decision making layers namely brand layer, business layer, financial-functional layer, operational layer and technology layer. The problems and solutions of the contact centre are arrived at through a top-down approach on the layers of the decision making to deliver results as per the business expectations. The impact of a contact centre on the business depends upon a chain of decisions including the strategic and business needs of the organization, the financial and customer experience parameters, operational metrics and the technology blocks. The CIM blueprint identifies the current position of the contact management against standard practices observed in the contact centers across the world. Furthermore the CIM blueprint is a design methodology which aligns technology with the business where the output from the each stage of the design methodology is used for creating a multi-year business design for the contact management, which is the basis for technology design.

The process of creating a CIM blueprint includes four stages such as assessing a current position of the contact management, analyzing the gaps in the contact management, advising a suitable blueprint to cover the gaps and assisting in the implementation of the blueprint to the contact management. In the assessing stage, a comprehensive assessment is conducted to arrive at the current position of the contact management in an organization. Based on the brand and the business objectives of the organization, a target position of the contact management is plotted using the assessment. In the analyzing stage, the gap between the current and ideal states of the contact management is identified. The gap between the current and ideal states of the contact management is equivalent to the gap between customer's expectation and experience. The current and ideal states of contact management is arrived at and illustrated using a construct which uses cost, revenue and experience metrics. Also the measures are conceptualized to cover the gap between the current and ideal states of the contact management. In the advising stage, a suitable CIM blueprint is designed to cover the gap between the current and ideal states of the contact management. In the assisting stage, the CIM blueprint is implemented by assistance during implementation bottlenecks, competency augmentation, audit and calibration and re-blueprints.

The CIM blueprint employs a series of analytical techniques to arrive at the current position of the contact centre against its maturity lifecycle and to identify opportunities for improvements. The CIM blueprint executes a plurality of different assessment techniques such as contact centre positioning, CIM indexing, activity based costing, business process mapping, customer experience management, customer behavior analysis, capacity modeling, process and quality management and technology assessment.

The contact centre brand to positioning assessment is performed to identify the role of the contact centre and arrive at the key objectives of the contact centre. This assessment involves discussions with key stakeholders of the organization on understanding the contact management strategies of the organization. The assessment analyses whether the organization is able to provide its value to the customers in terms of cost, products, or services. Also the assessment understands from the stakeholders as how do they envision the parameters getting implemented in various processes. The assessment links the parameters and arrives at the key positioning of the contact centre. In the assessment process, discussions are held with the key stakeholders of the contact centre to drive into key positioning statements for the contact centre. Further the assessment based on the discussion converts the key positioning statement into a set of objectives for the contact centre.

The CIM indexing assessment uses a CIM indexing framework as a primary framework. The CIM indexing framework is a compendium of practices used across the globe structured as standard, best and next practices. The existing practices are then assessed against these practices and a scoring is attempted. The assessment of each practice needs thorough understanding of the current processes, interviewing employees, gathering data, executing surveys and the like.

The activity based costing assessment provides an in-depth analysis for identifying the operational inefficiencies of the contact management. The analysis is ideal for the organizations that need to improve the operational efficiencies and/or to reduce costs through work flow/process improvements or technology implementations. The analysis also provides an insight to the improvement measures which can render cost reduction or highest Return on Investment (ROI) before implementing such improved measures.

The activity based costing assessment provides the correct and complete cost of each activity performed by the contact centre and also identifies the significant operational inefficiencies of the contact centre including the ones that are hidden from the view. Also the activity based costing assessment is able to quantify the impact of various cost reduction scenarios resulting from process or work flow improvements and technology implementations and are able to back up the improvements with provable hard dollar discounted ROI. The activity based costing assessment determines the impact of various contact centre demand drivers such as customer growth, new product announcements, acquisitions, improvements in technical aspects of a product on the demand of the contact centre and associated costs. The activity based costing assessment has an improvement-initiative roadmap which allows the user to determine what to do or buy and when to produce the fastest and/or best possible long term ROI based on the current and forecast demand. Further the activity based costing assessment understands the cost of status quo and is able to demonstrate the need for change using the compelling and ROI based business cases. The activity based costing assessment measures the performance of actual improvements against the planned improvements and thus is able to significantly reduce the time, expense and hassle associated with developing and maintaining the contact centre operating budgets especially at rapidly changing business conditions.

In the business process mapping assessment, the point of initiation and the point of conclusion of many processes in the organization can be viewed in the contact centre. The customers can canvass the processes and make a decision on the goods and service delivered through them at this point of interaction. Also gaps and inefficiencies in the processes get themselves translated into the customer interaction management. A clearly documented process map for workflows within the customer interaction management is this required as a reference when one arrives at gaps in process and later arriving at solutions for optimization. The business process mapping assessment analyses these processes through the customer interaction frame work. The business process mapping assessment analyses the reason for the customer's call against the multiple dimensions like nature of transactions such as interactions for information, interactions for grievances and interactions for transactions and products and services such as product segmentation and customer segmentation. The processes are analyzed at the point of permutations of the aforementioned dimensions. The emphasis is significantly focused on parts of the processes that flow through the customer interaction management as compared with the back end processes.

The customer experience management assessment evaluates the translation of strategic organization objectives into customer experience objectives by determining whether well-defined objectives are implemented to improve the customer experience, whether these objectives are linked to the strategic objectives at an organization level and whether the stakeholders understand the customer experience objectives. Further the customer experience management assessment analyses the implementation of the customer experience objectives in processes and policies of the customer interaction management by determining the method of implementation of the customer experience objectives on ground, the method of implementation of functions which have to work closely with the customer interaction management, study of latest customer surveys done by a third party internally and execution of a customer survey for a sample set.

The customer experience management assessment reviews the metrics used to measure the effectiveness of customer experience impacting processes by analyzing the method of measurements such as frequent customer surveys, mystery shopping, online real time customer surveys and continuous customer experience management systems, the interpreted measurements and the interpretations assimilated back into the process.

The customer behavior analysis assessment determines the self-service potential of the organization. The customer behavior analysis assessment uses the parameters such as self-service foot print audit, self-service traffic modeling, mystery shopping, self-service analytics and cross channel views to find the self-service potential of the organization.

The capacity modeling assessment matches the workload forecasts for a particular time period with that of capacity planned as long term, for instance yearly, short term (for example monthly or weekly) and very short term (for example daily). On a long term basis the capacity modeling assessment examines the balance between workload expected and capacity planned. The workload and capacity are modeled with a set of inflationary parameters like service times and call ratio representing calls per subscriber per month which are in turn affected by product mix and demographic mix. Further the workload and capacity are modeled with a set of deflationary parameters like self service penetration, alternate channel recruitment and call avoidance initiatives.

The process and quality management assessment is a step-by-step approach that assesses the current operations setup at the contact center. The service looks at the processes of call control, agent feedback and call quality. The assignment assesses current operations and compares them with the global industry standards to bring out the critical points which are important to achieve excellence in customer service and to bring out the process changes. The process and quality improvement assessment is an assessment of the current customer interaction landscape of the organization across the two roles of agent and supervisor where the agent handles customer service etiquette and call quality and the supervisor handles the contact centre management skills, coaching, call monitoring and feedback. The capacity modeling assessment moves along the four layers of competency, knowledge and skill, training, design and gap analysis, skill development tools and processes and performance management.

The technology assessment involves the assessment of the performance of the current contact centre technology and architecture with the industry benchmarks and trends. The technology assessment covers the infrastructure and blueprints (for example Private Branch Exchange (PBX)/Automatic Call Distributor (ACD), ACD/PBX Reporting, Computer Telephony Integration (CTI) systems and reporting, Interactive Voice Response (IVR) platform and application, host and middleware interfaces, voice recording systems, Fax applications and desktop applications), interfaces (for example ACD network/CTI link/tie trunking, IVR/interface, hosts response times and data interface processes), infrastructure sizing (for example telephony infrastructure, PBX/ACD lines and licenses, IVR, agents and load balancing) and Management Information system (MIS) such as standard reports generated, failure reports, and the like.

In the problem identification process, all the different assessments typically bring in a long list of potential problem areas. The CIM indexing is then deployed to identify the problems which are a manifestation of the extent of usage of a practice, which have the maximum impact on the cost, revenue and/or experience variables and in the measures as desired by the positioning. The identified problems are then categorized into workable programs that can be managed and substantiation is also provided for the problem areas. For example, the top two or three gaps within each of the CIM indexing practices are identified. The CIM indexing practices are standard, best and next which help the contact operation to move up the maturity life cycle. Each of the gaps is further analyzed for root causes, the assessed opportunity loss, solutions identified and impact measured either in terms of cost savings or customer experience.

During the solution identification process, the identified problems are analyzed and the solutions are then listed for their impact on the positioning levers of cost, experience and revenue. The solutions are then designed and elaborated from strategy, people and process and technology enablers' perspective.

The solution design for the business includes a set of improvement initiatives also called as the bill of improvement. The business design deliverables include high level improvement initiatives quantified as much as possible in money terms on its impact either on customer experience or cost/revenue from operations. Further the implementation recommendations on the business design initiatives including the suggested sequence, priority, criticality and a time phased plan such as long term (for example up to 5 years), medium term (for example 1 to 3 years) and short term (for example less than an year).

For the solutions identified in business design, a technical design is put in place to ensure the successful implementation of the business design. The technical design for the customer interaction management refers to concepts and technologies which are arrived at after evaluating all the available options and keeping in mind the future roadmap/business design of the customer interaction management. The output of the business design is discussed, prioritized and short listed. The initiatives are further used for detaining the technical design.

The CIM blueprint performs a Strengths-Weaknesses-Opportunities-Threats (SWOT) analysis of the technology design and component options so as to choose the right design for the improvement initiatives identified in the business design. The technology design involves the modules such as analysis of the required call parameters like call time, call traffic etc., architecture blueprint with all technology components, evaluation of various technologies, components and applications for the customer interaction management, sizing, integration design with existing network, hosts, applications, design finalization and roadmap for the technology. The customer interaction management design chooses the technology components based on the requirements of improvement initiatives identified in the business design stage. The technology components are basic technology design (for example Voice over Internet Protocol (VoIP)/Time-Division Multiplexing (TDM), central/distributed architecture), telephony environment (for example telephony access and switch), web/e-contact access systems (for example e-mail management systems and chat access), voice self service applications (for example IVR infrastructure, call flows and call routing, host and database access and Personal Identification Number (PIN) access and authentication), contact routing mechanisms (for example ACD and skill based routing), computer telephony interaction (for example business rules for CTI and all routing), quality monitoring solutions, out dialing solutions, MIS (for example customer interaction management efficiency and effectives index reporting design, ACD reporting, IVR reporting and CTI reports), workforce management systems and integration requirements (for example integration of telephony components, CTI integration and integration with hosts and middleware).

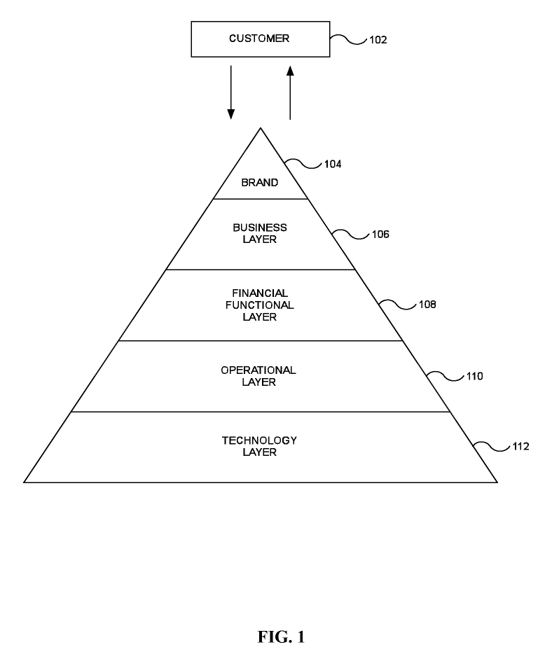

FIG. 1 illustrates a functional block diagram of a Customer Interaction Management (CIM) blueprint according to an embodiment of the present disclosure. With respect to FIG. 1, a brand 104 of an organization promises a customer 102 to have an expectation on the products and services of the organization. The customer 102 interacts with the customer interaction management of the organization. A CIM blueprint includes a plurality of decision making layers including a business layer 106, financial functional layer 108, operational layer 110 and technology layer 112. The final impact of the contact management on the business is depended upon a chain of decisions. The chain of decisions started from the strategic and business needs of the organization flows down the financial and customer experience parameters into operational metrics in which most of the contact centre managers are familiar with and then finally into the technology layer 112. The business layer 106 takes decisions including objectives of customer service contact management with respect to customer expectation and strategic objectives to be adapted by the organization. The decisions regarding the financial parameters are taken at the financial layer 108. The operational layer 110 decides on the operations metrics that demonstrate the effectiveness of the improvement initiatives and the solutions enablers to help achieve the operational metrics. The technology layer 112 takes decision regarding technology dependencies and the technology enables that will aid the solution.

The problems and solutions of the contact management are arrived at through the top-down approach to deliver the results as per the business expectations. The CIM blueprint assures that the technology aligns with the business where the output from the each stage is used for creating a multi-year business design for the contact management. The business design in turn forms the base for technology design.

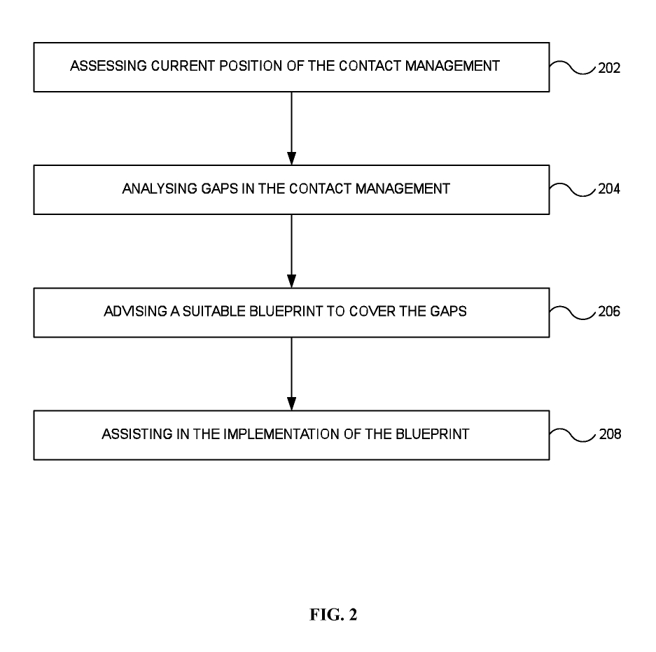

FIG. 2 illustrates a flowchart representing a method of diagnosing maturity of a contact management in an organization using a Customer Interaction Management (CIM) blueprint according to an embodiment of the present disclosure. With respect to FIG. 2, the methodology of the CIM blueprint includes a comprehensive assessment to determine the current position of a contact management in an organization based on the assessment techniques such as CIM indexing, activity based costing, contact centre positioning, customer experience management, customer behavior analytics, capacity modeling, people and quality processes, technology assessment and business process mapping. Based on the brand and the business objectives of the organization, a target position of the contact management plotted using the comprehensive assessment (step 202).

The CIM blueprint analyses the contact management to identify the gap between the current state and ideal state of the contact management based on the CIM indexing, problem definition and problem categorization (step 204). The gap between the current state and the ideal state of the contact management is equivalent to the gap between customer's expectation and experience. Also a gap statement is prepared and the measures are conceptualized to cover the gap between the current state and the ideal state of the contact management. Then the CIM blueprint advices business and technology designs to cover the gap between the current state and the ideal state of the contact management by providing solution definition, impact statement, solution components and solution design (step 206). Further the CIM blueprint assists to implement the business and technology designs by executing implementation bottlenecks, competency augmentation, audit and calibrations and re-blueprint of the designs (step 208).

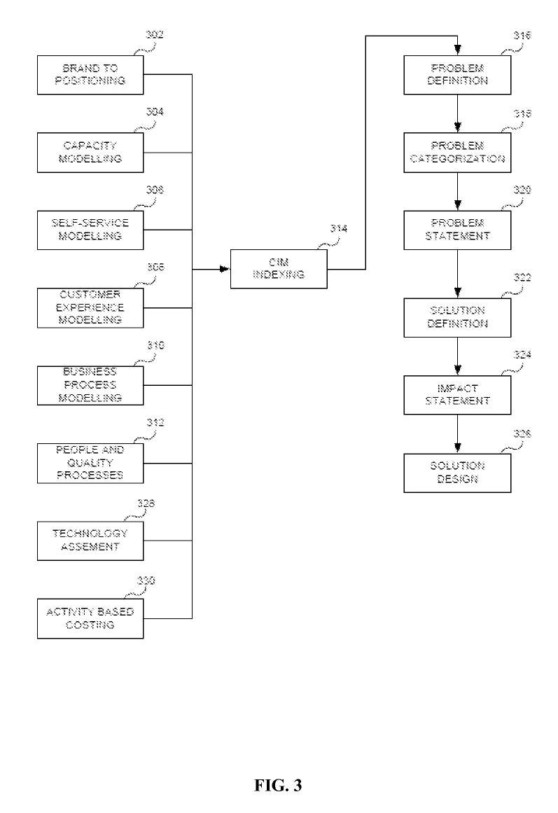

FIG. 3 illustrates a flowchart representing a method of identifying problem and solution statements for contact management of an organization using a Customer Interaction Management (CIM) indexing according to an embodiment of the present disclosure. With respect to FIG. 3, the methodology of the CIM blueprint includes various assessment techniques such as brand-to-positioning for discovering the role of the contact management and arriving at the key objectives of the contact management (step 302), capacity modeling for identifying the right size of the contact management (step 304), self-service modeling for exploring true self-service potential of the contact management (step 306), customer experience modeling for identifying the satisfaction level of the customers (step 308), business process modeling for measuring maturity of contact management in process mapping (step 310), people and quality processes for identifying the performance of the members in the organization (step 312), technology assessment to judge whether the employed technology is aligned with the business under operation (step 328) and activity based costing to determine the true cost of a service activity (step 330). The CIM blueprint provides a CIM indexing to arrive at the current position of the contact management in the contact management maturity cycle of the organization based on the assessment techniques. The CIM indexing is a compendium of practices used across the globe structured as standard, best and next practices. The current position of the contact management is assessed against these practices and scoring is attempted (step 314). Based on the business objectives of the organization, a target position of the contact management is plotted. The CIM blueprint identifies the problems in the current position of the contact management (step 316) and categorizes the identified problems in the current position of the contact management based on the weightages (step 318). Also the measures are conceptualized based on the problem statement to cover the gap between the current state and ideal state of the contact management based on the problem statement (step 320). Then the CIM blueprint provides suitable business and technology designs to cover the gap between the current and ideal states of the contact management by providing solution definition (step 322), impact statement on the positioning parameters of cost, experience and revenue (step 324) and solution design (step 326).

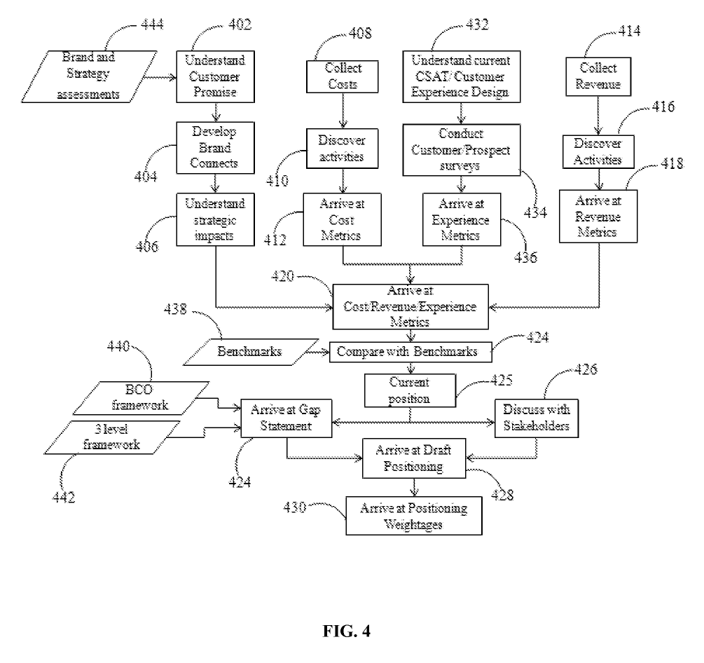

FIG. 4 illustrates a flowchart representing a method of finding brand-to-positioning based on weightages for cost, revenue and experience of a contact management of an organization using a Customer Interaction Management (CIM) indexing according to an embodiment of the present disclosure. With respect to FIG. 4, the CIM blueprint includes brand and strategy assessments (step 444) to understand the promise of the brand on the customer and the expectation of the customer on the brand (step 402). Based on the assessment, the blue print includes innovative measures to develop brand connections with the customer (step 404). The CIM blueprint understands the strategic impacts and aligns the contact management with the strategic needs of an organization (step 406). Further the CIM blueprint collects the cost activities of the contact management (step 408) to know the correct and complete cost of the specific activities performed by the contact centre (step 410) and arrives at the cost metrics to identify significant operational inefficiencies of the contact management (step 412). A survey of a selected sample of customers and prospects are done to understand the current state of experience (step 432) and conducts customer surveys and reviews the current programs (step 434) to arrive at the customer experience metrics at step 436. The CIM blueprint also collects the revenue (step 412) of the organization (step 414) to know the revenue from the activities performed by the contact centre (step 416). Further, the blue print arrives at the revenue metrics to identify the significant operational inefficiencies of the contact management (step 418). The strategic impacts of the CIM in the organization, the cost metrics, the revenue metrics and the experience metrics are then analyzed at step 420. The cost/experience/revenue metrics are them compared with the standard benchmarks to arrive at the current position of CIM in the organization (step 422, 425, 438). The industry benchmarks based on cost, customer experience and revenue are used to arrive at the existing gaps (step 425). Further discussions with key stakeholders are held for understanding the desired positioning based on the proposed ideal thrust for cost, customer experience and revenue dimensions. The positioning gap statement is illustrated using a High-Low scale of 3 dimensions namely cost, customer experience and revenue. The revenue dimension is used only if the instance being studied is a revenue generating activity. Two constructs namely BCO framework and 3 lever frame work is also used to analyze the gaps. The BCO construct interlinks the three dimensions of brand, customer experience and organization. The three lever framework plots the current and desired positioning on a scale of three sets of dimensions namely, reactive-proactive, remote-high touch and response oriented-resolution oriented (step 426). Based on the gap statement and discussions with the stakeholders, the CIM blueprint arrives at a draft positioning of the contact management of the organization (step 428). Further the CIM blueprint provides the CIM indexing having weightages for cost, revenue and experience based on the desired positioning of the contact management (step 430).

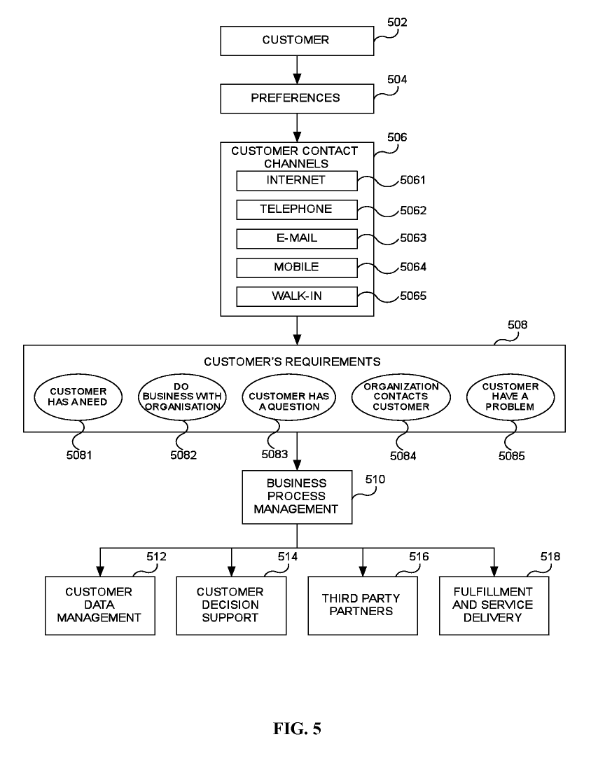

FIG. 5 illustrates a functional block diagram representing an example customer interaction framework to identify maturity of a contact management in process mapping for workflow management according to an embodiment of the present disclosure. With respect to FIG. 5, a customer interaction framework includes a point of initiation and a point of conclusion of the customer management processes in an organization. A customer 502 makes a decision on the products and services delivered by the organization based on the experience of the customer management processes of the organization. The customer 502 having preferences 504 approaches the organization through any one of customer contact channels 506 such as internet 5061, telephone 5062, e-mail 5063, mobile 5064, walk-in 5065 and so on. The customer 502 may have one or more requirements from the organization. The customer's requirements 508 include interactions for products and services, grievances, transactions like customer has a need 5081, do business with the organization 5082, customer has a question 5083, organization contacts customer 5084, customer has a problem 5085 etc. The customer's requirements 508 are linked to the business process management 510. The business process management 510 of the customer interaction framework analyses the nature of the customer's requirements 508 and links to appropriate branches like customer data management 512, customer decision support 514, third party partners 516, fulfillment and service delivery 518 and so on. The customer interaction framework provides clearly documented process maps for workflows within the contact management.

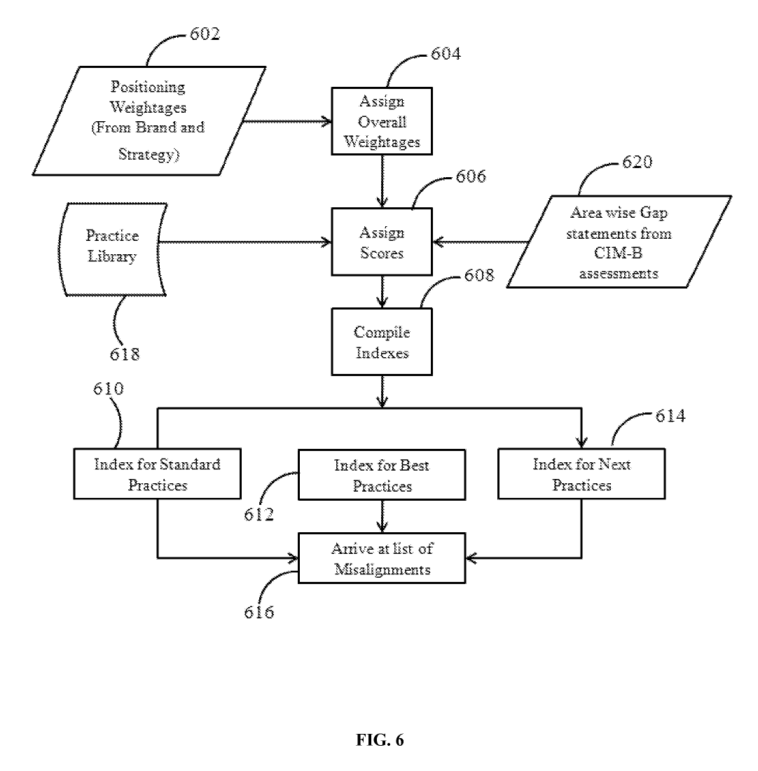

FIG. 6 illustrates a flow chart explaining the method of Customer Interaction Management (CIM) indexing according to an embodiment of the present disclosure. The CIM position assessment uses a CIM indexing framework as a primary framework. The CIM indexing framework is a compendium of practices used across the globe structured as standard, best and next practices. The existing practices are then assessed against these practices and a scoring is attempted. The assessment of each practice needs thorough understanding of the current processes, interviewing employees, gathering data, executing surveys and the like.

The indexing framework obtains the weightage of the contact management positioning from the brand and strategy of the organization (step 602). The overall weightages thus obtained is then assigned on the currently existing contact management (step 604). Then scores are assigned on the current position of the contact management (step 606) based on the overall weightages assigned, practice library (618) and area wise gap statements from customer interaction management business assessments (step 620). The CIM framework then compile the indexes (step 608) and categorizes the overall index as index for standard practices (step 610), index for best practices (step 612) and index for next practices (step 614). The standard practices, best practices and next practices are then compared to arrive at a list of misalignments in the currently existing contact management (616).

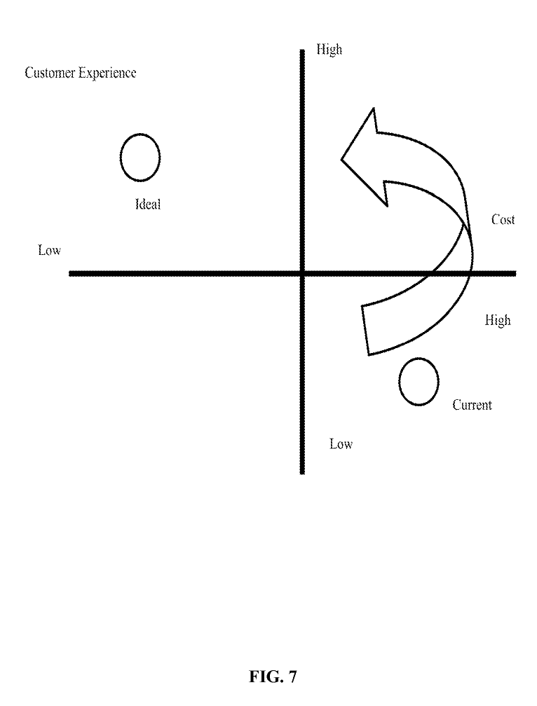

FIG. 7 illustrates a schematic representation of current and ideal state of contact positioning in a Customer Interaction Management (CIM) blueprint according to an embodiment of the present disclosure. The CIM blue print uses comprehensive assessment methods to derive the current position of the contact management in an organization. Further, an ideal position of the contact management is plotted using the assessment based on the business objectives of the organization. The gap between the current position and the ideal position of the contact management is equivalent to the gap between the customer's expectation and experience. The current position and the ideal position of the contact management is then illustrated using a construct which uses cost, revenue and experience metrics as shown in FIG.7. The illustration provides an output including contact management positioning statement and positioning imperatives on operations.

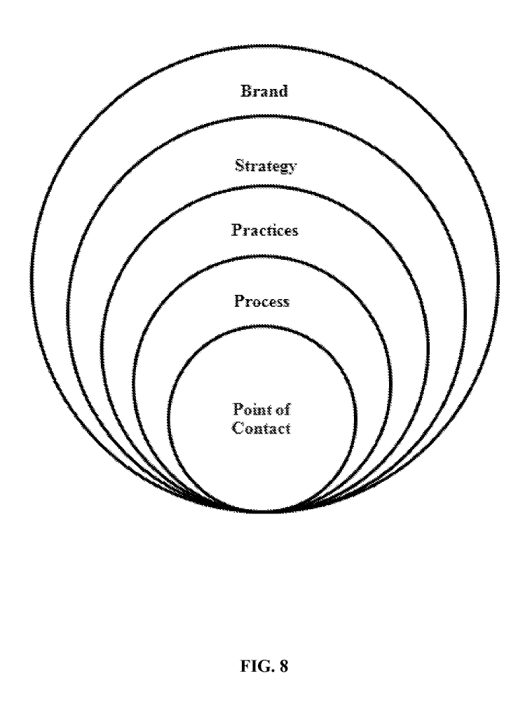

FIG. 8 illustrates a schematic representation of a CIM indexing framework according to an embodiment of the present disclosure. With respect to FIG. 8, the CIM indexing is deployed to identify the problems which are a manifestation of the extent of usage of a practice, which have the maximum impact on the cost, revenue and/or experience variables and in the measure as desired by the positioning. The CIM index in the CIM blueprint is a knowledge framework which has practices used in a wide variety of centers across the world arranged and indexed by their natural influence to impact cost per call, customer experience and revenue per call as the key levers to optimize. The hierarchy in the structure includes a brand which drives the strategic positioning, drives the practices which apply on the processes and then impacts the interaction at the point of contact. The cost, revenue and experience will be the outcome of this drive. The processes are those essential specific functions without which an instance of contact management ceases to exist. Practices are initiatives/techniques used to drive the processes to achieve a specific cost/revenue/Experience objective.

The various embodiments of the present invention provide a CIM blueprint with business and technology designs to diagnose the contact management maturity lifecycle in an organization. The CIM Blueprint is a specialized diagnosis methodology to assess the maturity of contact management (i.e. contact centre) in an organization. The CIM blueprint functions as an optimization model that attempts to arrive at the improvement of opportunities for the contact management based on the contact management's strategic alignment to the positioning of the organization. The CIM blueprint is also designed in such a way that the CIM blueprint constantly absorbs newer practices into the framework. The CIM blueprint is also a bench marking tool for customer interaction managements to get assessed on their maturity to introduce and provide beneficial practices in the business centers.

The top-down design methodology of the CIM blueprint cascades customer interaction management decision making from the business layer to the financial-functional layer then to the operational layer and then finally to the technology layer. The CIM Index in CIM blueprint is a knowledge framework which has practices used in a wide variety of centers across the world arranged and indexed by their natural influence to impact cost per call, customer experience and revenue per call as the key levers to optimize.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method of providing a Customer Interaction Management (CIM) process comprising steps of:
assessing a current position of a customer interaction management in an organization;
analyzing gap between the current position and an expected position of the customer interaction management;
advising a blueprint to cover the gap between the current position and the expected position of the customer interaction management; and
assisting in the implementation of the blueprint to the customer interaction management;
wherein the customer interaction management blueprint cascades customer interaction management decisions using a plurality of layers comprising brand layer business layer, financial-functional layer, operational layer and technology layer.

2. The method of claim 1, wherein the method of assessing the current position of the customer interaction management is based on an interaction between a plurality of parameters comprising:
customer experience;
customer accessibility; and
capacity to deliver.

3. The method of claim 1, wherein the method of assessment of the current position of the customer interaction management comprises at least one of a series of assessment techniques including:
customer interaction management positioning;
customer interaction management indexing;
activity based costing;
business process mapping;
customer experience management;
customer behavior analysis,
capacity modeling;
process and quality management; and
technology assessment.

4. The method of claim 3, wherein the customer interaction management positioning for the assessment of the current position of the customer interaction management, comprising:
understanding parameters used for creating strategies of the organization by discussing with key stakeholders of the organization;
understanding a manner of creating the parameters getting implemented in the processes of the customer interaction management, from the key stakeholders of the organization;
linking the parameters to the manner of creating the parameters to arrive at a key positioning statement for the customer interaction management; and
converting the key positioning statement into a set of objectives for the customer interaction management to identify a role of the contact management.

5. The method of claim 3, wherein the customer interaction management indexing for the assessment of the current position of the customer interaction management, comprising:
understanding the current position of the customer interaction management against a customer interaction management indexing framework.

6. The method of claim 5, wherein the customer interaction management indexing framework for performing the assessment of the current position of the customer interaction management comprising:
providing a brand adapted to drive a strategic positioning of the contact management;
identifying the strategy to drive practices to be applied on processes; and
determining the extent of usage of the processes which impacts the interaction at a point of contact;
wherein the CIM indexing framework determines cost variable, revenue variable and experience variable to index the contact management practices of the organization.

7. The method of claim 3, wherein the activity based costing for the assessment of the current position of the customer interaction management, comprising:
analyzing operational inefficiencies in the current position of the customer interaction management; and
providing instructions adapted for implementing technologies and processes required for improving efficiency of work flow.

8. The method of claim 3, wherein the business process mapping for the assessment of the current position of the customer interaction management, comprising:
finding a point of initiation and a point of conclusion of the processes analyzed through a customer interaction management framework; and
creating business process maps for the processes in the customer interaction management.

9. The method of claim 3, wherein the customer experience management for the assessment of the current position of the customer interaction management, comprising:
assessing objectives implemented to improve the customer experience and objectives linked to the strategic organization objectives at the organization level;
assessing customer experience objectives understood by stakeholders;
translating the strategic organization objectives into the customer experience objectives;
implementing the customer experience objectives in processes and policies of the customer interaction management; and
employing reviewing metrics to measure effectiveness of the improved customer experience processes.

10. The method of claim 3, wherein the capacity modeling for the assessment of the current position of the customer interaction management, comprising:
matching workload forecasts with the customer interaction management capacity forecasted for a period of time;
examining a balance period between workload and capacity forecasted, wherein the workload and capacity are modeled with a set of inflationary and deflationary parameters; and
assessing capacity of the customer interaction management based on the balance period.

11. The method of claim 3, wherein the customer behavior analysis for the assessment of the current position of the customer interaction management, comprising:
identifying the self service potential of the organization using work elements, wherein the work element includes at least one of a self-service foot print audit, self-service traffic modeling, mystery shopping, self-service analytics and cross channel views.

12. The method of claim 3, wherein the process and quality management for the assessment of the current position of the customer interaction management, comprising:
assessing at least one current operation setup at the customer interaction management; and
comparing the current operation with standard practices; and
identifying the critical points in the customer interaction management processes to provide improved customer service.

13. The method of claim 3, wherein the technology assessment for the assessment of the current position of the customer interaction management, comprising:
assessing a performance of a current technology and a current architecture used in the customer interaction management with industry benchmarks and trends.

14. The method of claim 1, wherein the method of analyzing the gap between the current position and the expected position of the customer interaction management, further comprising:
identifying problems in the positioning of the customer interaction management from the series of assessment techniques;
categorizing the identified problems;
using the CIM indexing framework to arrive the problems having highest impact on positioning; and
providing substantiation for the identified problems.

15. The method of claim 1, wherein the method of advising of a blueprint to cover the gap between the current position and the expected position of the customer interaction management, further comprising:
providing solutions for identified problems;
listing the solutions for the problems in positioning of the customer interaction management;
building a business design having a set of improvement initiatives for the solutions;
building a technology design for the solutions identified in the business design, wherein the technology design refers to concept and technologies of the customer interaction management.

16. The method of claim 1, wherein the method of assisting in the implementation of the blueprint to the customer interaction management, further comprising:
implementing bottleneck operations in business and technology designs of the customer interaction management;
processing competency augmentation, audit and calibrations in business and technology designs of the customer interaction management; and
modifying the blueprint according to requirements added in the customer interaction management framework.
